(19) United States
(12) Patent Application Publication
(10) Pub. No.: US 2018/0065611 A1
(43) Pub. Date: Mar. 8, 2018

(54) BRAKE CONTROL DEVICE AND CONTROL METHOD

(71) Applicant: HITACHI AUTOMOTIVE SYSTEMS, LTD., Ibaraki (JP)

(72) Inventor: Makoto MATSUURA, Nerima-ku, Tokyo (JP)

(21) Appl. No.: 15/560,010

(22) PCT Filed: Mar. 18, 2016
(86) PCT No.: PCT/JP2016/058650

§ 371 Date: Sep. 20, 2017

(30) Foreign Application Priority Data
Mar. 31, 2015 (JP) 2015-074003

(51) Int. Cl. B60T 13/66; B60T 8/171; B60T 8/172; B60T 8/32; B60T 13/74; B60L 7/18; B60L 7/26; B60L 15/20

(52) U.S. Cl. CPC B60T 13/662; B60T 8/171; B60T 8/172; B60T 8/3205; B60T 13/741; B60L 2240/14; B60L 7/26; B60L 15/2009; B60T 2260/09; B60T 2270/604; B60L 7/18

(57) ABSTRACT

A brake control device and a control method, which are capable of improving responsiveness of vehicle braking at a low temperature. The brake control device configured to brake a vehicle by a hydraulic pressure control mechanism configured to apply hydraulic pressure from a master cylinder to a wheel cylinder includes: a master cylinder hydraulic pressure detecting unit configured to detect or calculate a physical quantity relating to hydraulic pressure generated in the master cylinder; a wheel cylinder hydraulic pressure detecting unit configured to detect or calculate a physical quantity relating to hydraulic pressure of the wheel cylinder; and a control unit configured to control whether to output a braking instruction signal to another braking unit in accordance with a difference between the detected or calculated physical quantity of the hydraulic pressure of the master cylinder and the detected or calculated physical quantity of the hydraulic pressure of the wheel cylinder.

### TECHNICAL FIELD

The present invention relates to a brake control device and a control method, which are suitably used for a vehicle, for example, an automobile.

### BACKGROUND ART

There exists a brake control device to be mounted in a vehicle, for example, a four-wheeled automobile, which is configured to brake the vehicle by a hydraulic pressure control mechanism configured to apply a hydraulic pressure from a master cylinder to a wheel cylinder (see, for example, Patent Literature 1). In the brake control device disclosed in Patent Literature 1, an opening degree of an orifice provided to a hydraulic pipeline between the master cylinder and the wheel cylinder is adjusted in accordance with a temperature of a brake fluid.

### CITATION LIST

### Patent Literature

PTL 1: JP S63-63249 U

### SUMMARY OF INVENTION

### Technical Problem

In the brake control device disclosed in Patent Literature 1, the opening degree of the orifice is increased at a low temperature at which a kinetic viscosity of the brake fluid becomes high. In this manner, after a flow resistance of the brake fluid flowing through the orifice is reduced, the hydraulic pressure is applied from the master cylinder to the wheel cylinder. However, the brake control device described above includes the orifice itself. Therefore, there is a fear in that the hydraulic pressure of the wheel cylinder cannot be increased sufficiently and responsiveness of vehicle braking to an operation of a brake pedal is thus lowered.

The present invention has been made to solve the problem of the related art described above, and has an object to provide a brake control device and a control method, which are capable of improving responsiveness of vehicle braking at a low temperature.

### Solution to Problem

In order to solve the problem described above, according to one embodiment of the present invention, there is provided a brake control device, which is configured to brake a vehicle by a hydraulic pressure control mechanism configured to apply a hydraulic pressure from a master cylinder to a wheel cylinder. The brake control device includes: a master cylinder hydraulic pressure detecting unit configured to detect or calculate a physical quantity relating to a hydraulic pressure generated in the master cylinder; a wheel cylinder hydraulic pressure detecting unit configured to detect or calculate a physical quantity relating to a hydraulic pressure of the wheel cylinder; and a control unit configured to control whether or not to output a braking instruction signal to another braking unit provided in the vehicle in accordance with a difference between the physical quantity of the hydraulic pressure of the master cylinder, which is detected or calculated by the master cylinder hydraulic pressure detecting unit, and the physical quantity of the hydraulic pressure of the wheel cylinder, which is detected or calculated by the wheel cylinder hydraulic pressure detecting unit.

Further, according to another embodiment of the present invention, there is provided a brake control method for braking a vehicle by a hydraulic pressure control mechanism configured to apply a hydraulic pressure from a master cylinder to a wheel cylinder. The brake control method includes: detecting or calculating a physical quantity relating to a hydraulic pressure generated in the master cylinder; detecting or calculating a physical quantity relating to a hydraulic pressure of the wheel cylinder; and determining need to brake the vehicle by a method other than application of the hydraulic pressure to the wheel cylinder, in accordance with a difference between the detected or calculated physical quantity of the hydraulic pressure of the master cylinder and the detected or calculated physical quantity of the hydraulic pressure of the wheel cylinder.

### Advantageous Effects of Invention

According to the embodiments of the present invention, responsiveness of brake control can be improved even at a low temperature.

### BRIEF DESCRIPTION OF DRAWINGS

FIG. 1 is an overall configuration diagram for illustrating a vehicle to which a brake control device according to an embodiment of the present invention is applied.

FIG. 2 is an overall configuration diagram for illustrating the brake control device.

FIG. 3 is a block diagram for illustrating the brake control device.

FIG. 4 is a flowchart for illustrating control processing performed by the brake control device.

FIG. 5 is a characteristic line graph for showing a relationship in temporal change between a master cylinder pressure and a wheel cylinder pressure.

FIG. 6 is a characteristic line graph for showing a movement amount of a piston of the master cylinder with respect to a wheel cylinder hydraulic pressure in a modification.

### DESCRIPTION OF EMBODIMENTS

Now, a brake control device according to an embodiment of the present invention is specifically described referring to the accompanying drawings, taking a brake control device to be mounted in a four-wheeled automobile as an example.

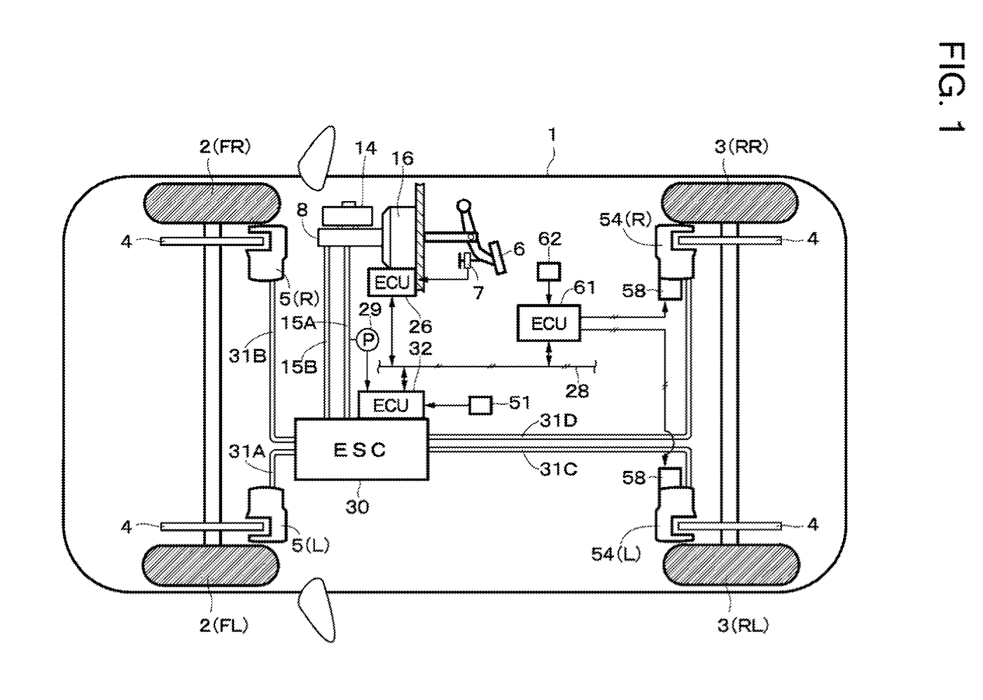

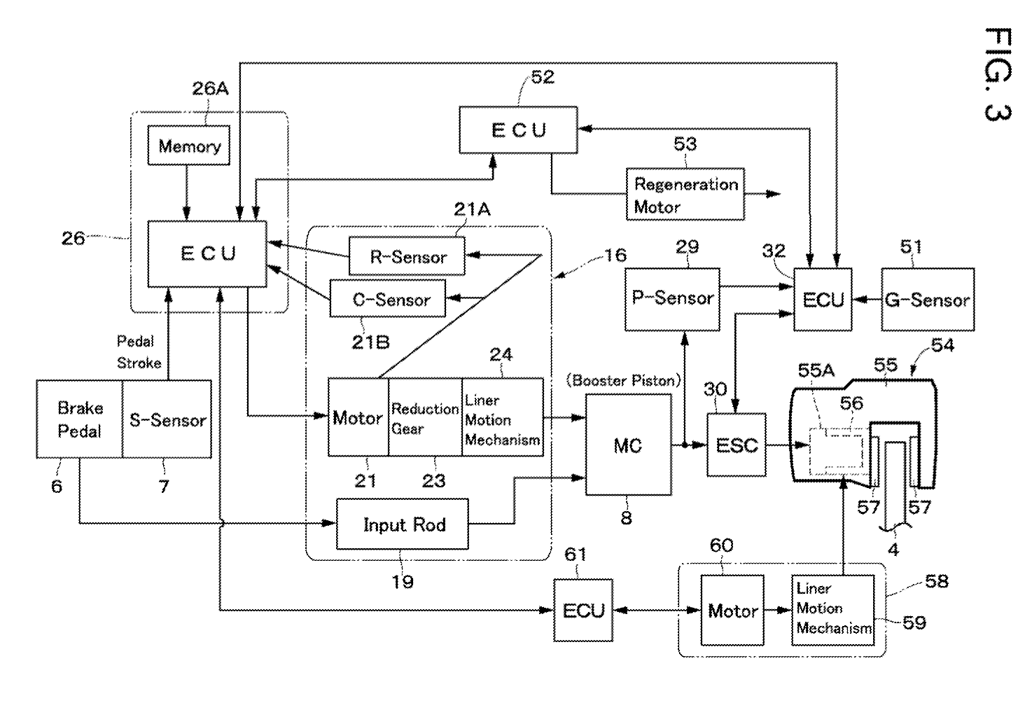

In FIG. 1 to FIG. 5, a brake system including the brake control device according to the embodiment of the present invention is schematically illustrated. In FIG. 1, four wheels including, for example, left and right front wheels 2 (FL, FR) and left and right rear wheels 3 (RL, RR) are provided to a lower side (on a road surface side) of a vehicle body 1 constructing a body of a vehicle. Disc rotors A serving as rotary members (discs), which are rotated together with the front wheels 2 and the rear wheels 3, are provided to the front wheels 2 and the rear wheels 3, respectively.

Hydraulic disc brakes 5 (L, R) are provided to the front wheels 2, respectively. For each of the front wheels 2, the disc rotor 4 is sandwiched by applying a hydraulic pressure to a wheel cylinder of each of the disc brakes 5 (L, R), resulting in application of a braking force. Hydraulic disc brakes 54 (L, R) described later, each having an electric parking brake function, are provided to the rear wheels 3, respectively. For each of the rear wheels 3, the disc rotor 4 is sandwiched by applying a hydraulic pressure to a wheel cylinder 55A of each of the disc brakes 54, resulting in application of a braking force. Further, each of the disc brakes 54 actuates an electric actuator 58 to hold the disc rotor 4. In this manner, the braking force can be applied to each of the rear wheels 3.

Specifically, the brake control device according to the present invention is configured to brake the vehicle by a hydraulic pressure control mechanism configured to apply the hydraulic pressures to the wheel cylinders (the disc brakes 5 and 54) from a master cylinder 8 described later.

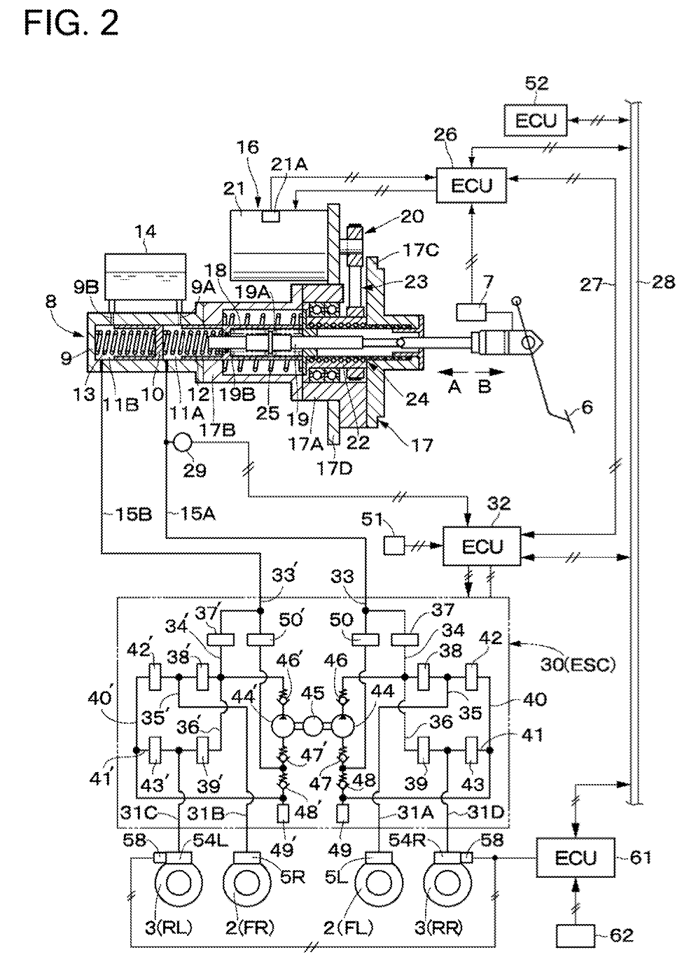

A brake pedal 6 is provided on a front board (not shown) side of the vehicle body 1. The brake pedal 6 is operated by a driver to foe stepped on in a direction indicated by the arrow A of FIG. 2 at the time of a braking operation for the vehicle. A stroke sensor 7 is provided to the brake pedal 6. The stroke sensor 7 detects a depressing operation amount (a stroke amount) or a depressing force on the brake pedal 6, and outputs a detection signal thereof to a first ECU 26 described later. When the depressing operation is performed on the brake pedal 6, a master cylinder hydraulic pressure (master pressure Pm) is generated in the master cylinder 8 via an electric booster 16 described later.

As illustrated in FIG. 2, the master cylinder 8 includes a cylinder main body 9 having a cylindrical shape with a closed end. The cylinder main body 9 has an open end on one side and a bottom portion on the other side. The cylinder main body 9 has a first supply port 9A and a second supply port 9B which communicate to an inside of a reservoir 14 described later. The first supply port 9A is brought into communication to and blocked from a first hydraulic chamber 11A by a sliding displacement of a booster piston 18 described later. Meanwhile, the second supply port 9B is brought into communication to and blocked from a second hydraulic chamber 11B by a second piston 10 described later.

The open-end side of the cylinder main body 9 is removably firmly fixed to a booster housing 17 of the electric booster 16 described later by using a plurality of mounting bolts (not shown) or the like. The master cylinder 8 includes the cylinder main body 9, a first piston (the booster piston 18 and an input rod 19 that are described later), the second piston 10, the first hydraulic chamber 11A, the second hydraulic chamber 11B, a first return spring 12, and a second return spring 13.

In this case, in the master cylinder 8, the first piston serving as a primary piston (namely, P-piston) includes the booster piston 18 and the input rod 19 that are described later. The first hydraulic chamber 21A formed inside the cylinder main body 9 is defined between the second piston 10 serving as a secondary piston and the booster piston 18 (and the input rod 19). The second hydraulic chamber 11B is defined inside the cylinder main body 9 between the bottom portion of the cylinder main body 9 and the second piston 10.

The first return spring 12 is located in the first hydraulic chamber 11A, and is provided between the booster piston 18 and the second piston 10 to bias the booster piston 18 toward the open-end side of the cylinder main body 9. The second return spring 13 is located in the second hydraulic chamber 11B, and is provided between the bottom portion of the cylinder main body 9 and the second piston 10 to bias the second piston 10 toward the first hydraulic chamber 11A.

In the cylinder main body 9 of the master cylinder 8, the booster piston 18 (input rod 19) and the second piston 10 are displaced toward the bottom portion of the cylinder main body 9 in accordance with the depressing operation of the brake pedal 6. Then, when the first supply port 9A and the second supply port 9B are blocked by the booster piston 18 and the second piston 10, respectively, the master pressure Pm is generated by the master cylinder 8 with use of a brake fluid in the first hydraulic chamber 11A and the second hydraulic chamber 11B. Meanwhile, in the case where the operation of the brake pedal 6 is released, the booster piston 18 (and the input rod 19) and the second piston 10 are displaced by the first return spring 12 and the second return spring 13 toward the opening portion of the cylinder main body 9 in a direction indicated by the arrow B. At this time, the master cylinder 8 releases the hydraulic pressure in the first hydraulic chamber 11A and the second hydraulic chamber 11B while being supplied with the brake fluid from the reservoir 14.

The reservoir 14 which stores the brake fluid therein is provided as a working-fluid tank to the cylinder main body 9 of the master cylinder 8. The reservoir 14 supplies and discharges the brake fluid to and from the hydraulic chambers 11A and 11B inside the cylinder main body 9. Specifically, while the first supply port 9A is kept in communication to the first hydraulic chamber 11A by the booster piston 18 and the second supply port 9B is kept in communication to the second hydraulic chamber 11B by the second piston 10, the brake fluid contained in the reservoir 14 is fed and discharged into the hydraulic chambers 11A and 11B.

Meanwhile, when the first supply port 9A is blocked from the first hydraulic chamber 11A by the booster piston 18 and the second supply port 9B is blocked from the second hydraulic chamber 11B by the second piston 10, the feeding and discharge of the brake fluid contained in the reservoir 14 to the hydraulic chambers 11A and 11B are interrupted. Therefore the master pressure Pm is generated in the first hydraulic chamber 11A and the second hydraulic chamber 11B of the master cylinder 8 along with a brake operation (an operation of the brake pedal 6). The master pressure Pm is transmitted to a hydraulic pressure supply device 30 described later via, for example, a pair of cylinder-side hydraulic pipes 15A and 15B.

The electric booster 16 is provided as a booster for increasing an operation force on the brake pedal 6 and as a brake device between the brake pedal 6 of the vehicle and the master cylinder 8. The electric booster 16 controls the driving of an electric actuator 20 described later based on the output from the stroke sensor 7, to thereby variably control the master pressure Pm generated in the master cylinder 8.

The electric booster 16 includes the booster housing 17, the booster piston 18, and the electric actuator 20 described later. The booster housing 17 is provided so as to be fixed to a front wall of a vehicle interior (not shown), which is the front board of the vehicle body 1. The booster piston 18 is provided to the booster housing 17 so as to be movable, and is movable relative to the input rod 19 described later. The electric actuator 20 described later is configured to move the booster piston 18 forward or backward in the axial direction of the master cylinder 8 and to apply a booster thrust force to the booster piston 18.

The booster piston 18 is formed of a cylindrical member which is slidably inserted and fitted into the cylinder main body 9 of the master cylinder 8 from the open-end side in the axial direction. On the inner circumferential side of the booster piston 18, the input rod 19 is slidably inserted and fitted. The input rod 19 is an input member which is directly pressed in accordance with the operation of the brake pedal 6 so as to be moved forward and backward in the axial direction of the master cylinder 8 (that is, in directions indicated by the arrows A and B). The input rod 19 constructs the first piston of the master cylinder 8 together with the booster piston 18, and the brake pedal 6 is connected to a rear side (one side in the axial direction) end portion of the input rod 19. Inside the cylinder main body 9, the first hydraulic chamber 11A is defined between the second piston 10 and the booster piston 18 (input rod 19).

The booster housing 17 includes a speed-reducer case 17A having a cylindrical shape, a supporting case 17B having a cylindrical shape, and a lid body 17C having a cylindrical shape with a step. The speed-reducer case 17A houses a speed-reducer mechanism 23 described later and the like therein. The supporting case 17B is provided between the speed-reducer case 17A and the cylinder main body 9 of the master cylinder 8, and supports the booster piston 18 so that the booster piston 18 is slidably displaceable in the axial direction. The lid body 17C is provided on the side opposite to the supporting case 17B in the axial direction (one side in the axial direction) through the speed-reducer case 17A therebetween, and closes an opening of the speed-reducer case 17A on one side in the axial direction. On the outer circumferential side of the speed-reducer case 17A, a support plate 17D for fixedly supporting an electric motor 21 described later is provided.

As illustrated in FIG. 2, the input rod 19 is inserted from the lid body 17C side into the booster housing 17, and extends inside the booster piston 18 in the axial direction toward the first hydraulic chamber 11A. A pair of neutral springs 19A and 19B is provided between the booster piston 18 and the input rod 19. The booster piston 18 and the input rod 19 are configured to be elastically retained in neutral positions by spring forces of the neutral springs 29A and 19B so that the spring forces of the neutral springs 19A and 19B act on an axial relative displacement thereof.

An end surface of the input rod 19 on a distal end side (the other side in the axial direction) is subjected to the hydraulic pressure generated in the first hydraulic chamber 11A at the time of the brake operation as a brake reaction force. The input rod 19 transmits the generated hydraulic pressure to the brake pedal 6. As a result, an appropriate pedal feeling is provided to the driver of the vehicle through the brake pedal 6. Thus, a good pedal feeling (good braking) can be obtained. As a result, an operation feel of the brake pedal 6 can be improved to maintain a good pedal feeling.

Further, the input rod 19 has the structure capable of coming into contact with the booster piston 18 to move the booster piston 18 forward when being moved forward by a predetermined amount with respect to the booster piston 18. With this structure, when the electric actuator 20 described later or the first ECU 26 fails, the booster piston 18 is moved forward by the depressing force applied to the brake pedal 6 so that the hydraulic pressure can be generated in the master cylinder 8.

The electric actuator 20 of the electric booster 16 includes the electric motor 21, the speed-reducer mechanism 23, for example, a belt, and a linear-motion mechanism 24, for example, a ball screw. The electric motor 21 is provided to the speed-reducer case 17A of the booster housing 17 through the supporting plate 17D therebetween. The speed-reducer mechanism 23 transmits the rotation of the electric motor 21 to a cylindrical rotary body 22 provided in the speed-reducer case 17a after reducing the speed of the rotation. The linear-motion mechanism 24 converts the rotation of the cylindrical rotary body 22 into an axial displacement (forward and backward movement) of the booster piston 18. The booster piston 18 and the input rod 19 have front ends (ends on the other side in the axial direction) exposed in the first hydraulic chamber 11A of the master cylinder 8, respectively, and generate the master pressure Pm in the master cylinder 8 by the depressing force (thrust force) transmitted from the brake pedal 6 to the input rod 19 and the booster thrust force transmitted from the electric actuator 20 to the booster piston 18.

Specifically, the booster piston 18 of the electric booster 16 forms a pump mechanism which is driven by the electric actuator 20 based on the output from the stroke sensor 7 (that is, a braking command) to generate the master pressure Pm in the master cylinder 8. A return spring 25 configured to constantly bias the booster piston 18 in a direction in which the braking is released (direction indicated by the arrow B of FIG. 1) is provided inside the supporting case 17B of the booster housing 17. At the time of release of the brake operation, the booster piston 18 is returned to an initial position illustrated in FIG. 2 in the direction indicated by the arrow B by a driving force generated when the electric motor 21 is rotated in a reverse direction, and a biasing force of the return spring 25.

The electric motor 21 is formed by using, for example, a DC brushless motor. A rotation sensor 21A called “resolver” and a current sensor 21B configured to detect a motor current are provided to the electric motor 21. The rotation sensor 21A detects a position of rotation of the electric motor 21 (motor shaft), and outputs a detection signal thereof to a control unit which is a first control circuit (hereinafter referred to as “first ECU 26”). The first ECU 26 performs feedback control of the electric motor 21 (that is, the booster piston 18) based on the rotation-position signal. The rotation sensor 21A has a function for detecting an absolute displacement of the booster piston 18 with respect to the vehicle body based on the detected position of rotation of the electric motor 21.

Here, together with the stroke sensor 7, the rotation sensor 21A is configured to detect a relative displacement between the booster piston 18 and the input rod 19. The detection signals of the rotation sensor 21A and the stroke sensor 7 are transmitted to the first ECU 26. The rotation sensor 21A is not limited to the resolver, but may also be a rotary potentiometer capable of detecting the absolute displacement (angle) or the like. Further, the speed-reducer mechanism 23 is not limited to the belt or the like, and may also be configured by using, for example, a gear speed-reducer mechanism or the like. Further, the linear motion mechanism 24, which converts the rotational motion into a translational motion, may be constructed by, for example, a rack-and-pinion mechanism or the like. Still further, the speed-reducer mechanism 23 is not necessarily provided. For example, the following configuration may be used. The motor shaft, is integrally provided to the cylindrical rotary body 22 and a stator of the electric motor is provided around the cylindrical rotary body 22. In this manner, the cylindrical rotary body 22 may be directly rotated as a rotor by the electric motor.

The first ECU 26 is made up of, for example, a microcomputer, and constructs a part of the electric booster 16 and also constructs control unit for the brake control device. The first ECU 26 constructs a master pressure control unit configured to electrically control the driving of the electric actuator 20 for the electric booster 16. An input side of the first ECU 26 is connected to the stroke sensor 7 configured to detect the operation amount of or the depressing force on the brake pedal 6, the rotation sensor 21A and the current sensor 21B of the electric motor 21, a signal line 27 mounted in the vehicle, for example, called “L-CAN”, which is capable of performing communication, a vehicle data bus 28 configured to transmit and receive a signal from an ECU 32, 52 or 61 of another vehicle equipment, and the like.

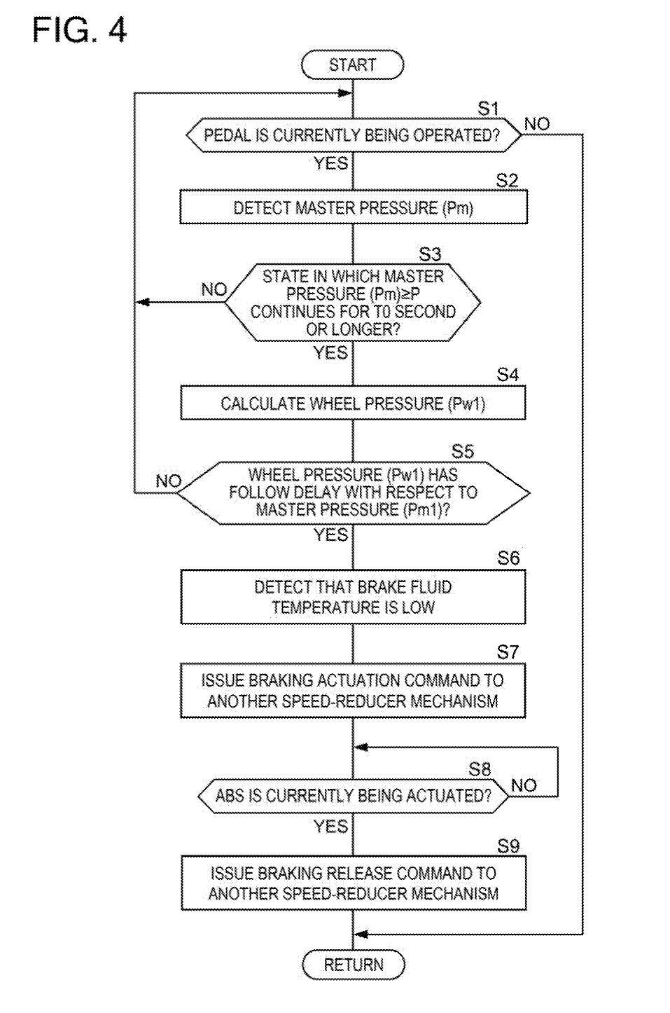

The first ECU 26 incudes a memory 26A. The memory 26A is made up of, for example, a flash memory, an EEPROM, a ROM, or a RAM. In the memory 26A, a processing program for controlling the electric booster 16 or the like is stored. Further, in the memory 26A, a processing program for executing a processing flow illustrated in FIG. 4 is stored.

Specifically, the first ECU 26 includes a master cylinder hydraulic pressure detecting unit serving as a master cylinder hydraulic pressure detecting means, a timer unit serving as a timer means for measuring a time period in which the master pressure Pm is equal to or larger than a predetermined value (threshold value P0), a wheel cylinder hydraulic pressure detecting unit serving as a wheel cylinder hydraulic pressure detecting means, a brake fluid temperature detecting unit serving as a brake fluid temperature detecting means for detecting a temperature of the brake fluid, and a braking instruction signal output unit serving as a braking instruction signal output means for outputting a braking instruction signal to the fourth ECU 61.

In this manner, the first ECU 26 determines whether or not responsiveness of the brake control performed based on the operation of the brake pedal 6 is lowered. When determining that the responsiveness of the brake control is lowered, the first ECU 26 outputs the braking instruction signal to the fourth ECU 61. Control processing for controlling the first ECU 26 to output the braking instruction signal to the fourth ECU 61 is described later.

The vehicle data bus 28 is a serial communication unit called “V-CAN” which is mounted in the vehicle, and performs multiplex communication to be mounted in the vehicle. Further, power is fed from an in-vehicle battery (not shown) through a power supply line (not shown) to the first ECU 26.

A hydraulic pressure sensor 29 is configured to detect the hydraulic pressure (master pressure Pm) of the master cylinder 8, and constructs the master cylinder hydraulic pressure detecting unit of the embodiment of the present invention. The hydraulic-pressure sensor 29 detects or calculates the hydraulic pressure in, for example, the cylinder-side hydraulic pipe 15A, and detects or calculates the master pressure Pin to be supplied from the master cylinder 8 to the hydraulic pressure supply device 30 described later via the cylinder-side hydraulic pipe 15A. In this embodiment, the hydraulic-pressure sensor 29 is electrically connected to the second ECU 32 described later. At the same time, a detection signal by the hydraulic-pressure sensor 29 is also transmitted through the communication from the second ECU 32 to the first ECU 26 via the signal line 27.

The hydraulic pressure sensor 29 may be provided to each of the cylinder-side hydraulic pipes 15A and 15B. Further, the hydraulic pressure sensor 29 may be mounted directly to the cylinder main body 9 of the master cylinder 8 as long as the master pressure Pm of the master cylinder 8 can be detected. Further, the hydraulic pressure sensor 29 may be connected so that a detection signal thereof can be input directly to the first ECU 26 without via the second ECU 32.

The first ECU 26 has an output side connected to the electric motor 21, the signal line 27, and the vehicle data bus 28 which are mounted in the vehicle. The first ECU 26 variably controls the master pressure Pm to be generated in the master cylinder 8 by the electric actuator 20 in accordance with the detection signals from the stroke sensor 7 and the hydraulic-pressure sensor 29. The first ECU 26 also has a function for determining whether or not the electric booster 16 is operating normally.

In the electric booster 16, when the depressing operation is performed on the brake pedal 6, the input rod 19 moves forward toward the cylinder main body 9 of the master cylinder 8. The movement of the input rod 19 at this time is detected by the stroke sensor 7. In response to the detection signal from the stroke sensor 7, the first ECU 26 outputs a start command to the electric motor 21 to rotationally drive the electric motor 21. The rotation of the electric motor 21 is transmitted to the cylindrical rotary body 22 via the speed-reducer mechanism 23. Then, the rotation of the cylindrical rotary body 22 is converted into the axial displacement of the booster piston 18 by the linear-motion mechanism 24.

At this time, the booster piston 18 moves forward integrally (or with a relative displacement as described later) with the input rod 19 toward the cylinder main body 9 of the master cylinder 8. As a result, the master pressure m in accordance with the depressing force (thrust force) applied from the brake pedal 6 to the input rod 19 and the booster thrust force applied from the electric actuator 20 to the booster piston 18 are generated in the first hydraulic chamber 11A and the second hydraulic chamber 11B of the master cylinder 8.

By receiving the detection signal from the hydraulic-pressure sensor 29 from the signal line 27 via the second ECU 32, the first ECU 26 can monitor the hydraulic pressure (master pressure Pm) generated in the master cylinder 8. In this manner, the first ECU 26 can determine whether or not the electric booster 16 is operating normally. Further, the first ECU 26 receives a detection signal from a G sensor 51 described later from the signal line 27 via the second ECU 32, by which the first ECU 26 can calculate a hydraulic pressure (wheel pressure Pw) of each of the wheel cylinders of the disc brakes 5 and the wheel cylinders 55A of the disc brakes 54.

Next, the hydraulic pressure supply device 30 is described.

The hydraulic pressure supply device 30 (ESC) is provided between the disc brakes 5 and 54 provided to the front wheels 2 side and the rear wheels 3 side of the vehicle and the master cylinder 8. The hydraulic pressure supply device 30 is configured to variably control the master pressure Pm generated by the electric booster 16 in the master cylinder 8 (the first hydraulic chamber 11A and the second hydraulic chamber 11B) as the wheel cylinder pressure Pw for each of the front wheels 2 and the rear wheels 3 to supply the wheel cylinder pressure Pw individually to each of the disc brakes 5 provided to the front wheels 2 and the disc brakes 54 provided to the rear wheels 3.

Specifically, when each of various types of brake control (for example, braking force distribution control for distributing the braking force to the front wheels 2L and 2R and the rear wheels 3L and 3R, anti-lock brake control, vehicle stabilization control, and the like) is performed, the hydraulic pressure supply device 30 supplies a necessary brake hydraulic pressure from the master cylinder 8 to each of the disc brakes 5 (L, R) and 54 (L, R) via the cylinder-side hydraulic pipes 15A and 15B and the like.

The hydraulic pressure supply device 30 distributes and supplies the hydraulic pressure output from the master cylinder 8 (first hydraulic chamber 11A and second hydraulic chamber 11B) via the cylinder-side hydraulic pipes 15A and 15B to the disc brakes 5 (L, R) and 54 (L, R) through brake-side pipe portions 31A, 31B, 31C, and 31D. In this manner, the independent braking force is individually applied to each of the front wheels 2L and 2R and the rear wheels 3L and 3R as described above. The hydraulic pressure supply device 30 includes control valves 37, 37′, 38, 38′, 39, 39′, 42, 42′, 43, 43′, 50, and 50′, an electric motor 45 configured to drive hydraulic pumps 44 and 44′, reservoirs 49 and 49′ for hydraulic-pressure control, and the like.

The second ECU 32 is a controller for the hydraulic-pressure supply device serving as a hydraulic pressure control unit configured to electrically control the driving of the hydraulic pressure supply device 30. An input side of the second ECU 32 is connected to the hydraulic-pressure sensor 29 the signal line 27, the vehicle data bus 28, the G sensor 51, and the like. An output side of the second ECU 32 is connected to the control valves 37, 37′, 38, 38′, 39, 39′, 42, 42′, 43, 43′, 50, and 50′, the electric motor 45, the signal line 27, the vehicle data bus 28, and the like.

The second ECU 32 individually controls the driving of the control valves 37, 37′, 38, 38′, 39, 39′, 42, 42′, 43, 43′, 50, and 50′, the electric motor 45 of the hydraulic pressure supply device 30, and the like as described later. In this manner, the second ECU 32 performs control for reducing, maintaining, boosting, or applying the brake fluid pressure to be supplied from the brake-side pipe portions 31A to 31D to the disc brakes 5 (L, R) and 54 (L, R) individually for the disc brakes 5 (L, R) and 54 (L, R).

Specifically, by controlling the actuation of the hydraulic pressure supply device 30, the second ECU 32 can execute, for example, the braking-force distribution control, the anti-lock brake control (ABS control), the vehicle stabilization control, hill start aid control, traction control, vehicle tracking control, lane departure avoidance control, and obstacle avoidance control. The braking-force distribution control appropriately distributes the braking force to each of the wheels 2 and 3 in accordance with a vertical load when the vehicle is braked. The anti-lock brake control (ABS control) prevents each of the wheels 2 and 3 from being locked by automatically adjusting the braking force for each of the wheels 2 and 3 at the time of braking. The vehicle stabilization control detects a skid of each of the wheels 2 and 3 during running to suppress understeer and oversteer while appropriately automatically controlling the braking force to be applied to each of the wheels 2 and 3 regardless of the operation amount of the brake pedal 6, thereby stabilizing a behavior of the vehicle. The hill start aid control assists in starting by maintaining a braked state on a hill (uphill, in particular). The traction control prevents each of the wheels 2 and 3 from spinning at the time of start of the vehicle. The vehicle tracking control allows a constant distance to be kept from a vehicle ahead. The lane departure avoidance control allows the vehicle to run on a driving lane. The obstacle avoidance control avoids the collision against an obstacle ahead or behind the vehicle.

The hydraulic pressure supply device 30 includes two-system hydraulic circuits, that is, a first hydraulic system 33 and a second hydraulic system 33′. The first hydraulic system 33 is connected to one of output ports (that is, the cylinder-side hydraulic pipe 15A) of the master cylinder 8 to supply the hydraulic pressure to the disc brake 5L for the left front wheel 2 (FL) and the disc brake 54R for the right rear wheel 3 (RR). The second hydraulic system 33′is connected to the other output port (that is, the cylinder-side hydraulic pipe 15B) to supply the hydraulic pressure to the disc brake 5R for the right front wheel 2 (FR) and the disc brake 54L for the left rear wheel 3 (RL). The first hydraulic system 33 and the second hydraulic system 33′ have the same configuration. Therefore, only the first hydraulic system 33 is described below. For the second hydraulic system 33′, the reference symbols of the respective components are followed by “′”, and the description thereof is herein omitted.

The first hydraulic system 33 of the hydraulic pressure supply device 30 includes a brake pipeline 34 connected to a distal end side of the cylinder-side hydraulic pipe 15A. The brake pipeline 34 branches into a first pipeline portion 35 and a second pipeline portion 36, which are connected to the disc brakes 5L and 54R, respectively. The brake pipeline 34 and the first pipeline portion 35 construct a pipeline for supplying the hydraulic pressure to the disc brake 5L together with the brake-side pipeline portion 31A, whereas the brake pipeline 34 and the second pipeline portion 36 construct a pipeline for supplying the hydraulic pressure to the disc brake 54R together with the brake-side pipeline portion 31D.

The brake fluid-pressure supply control valve 37 is provided to the brake pipeline 34. The supply control valve 37 is a normally-open electromagnetic selector valve for opening and closing the brake pipeline 34. A boost control valve 38 is provided to the first pipeline portion 35. The boost control valve 38 is a normally-open electromagnetic selector valve for opening and closing the first pipeline portion 35. A boost control valve 39 is provided to the second pipeline portion 36. The boost control valve 39 is a normally-open electromagnetic valve for opening and closing the second pipeline portion 36.

Meanwhile, the first hydraulic system 33 of the hydraulic pressure supply device 30 includes a first pressure-reduction pipeline 40 for connecting the disc brake 5L side and the reservoir 49 for hydraulic-pressure control and a second pressure-reduction pipeline 41 for connecting the disc brake 54R side and the reservoir 45. A first and second pressure-reduction control valves 42 and 43 are provided to these pressure-reduction pipelines 40 and 41, respectively. The first and second pressure-reduction control valves 42 and 43 are normally-closed electromagnetic selector valves for opening and closing the pressure-reduction pipelines 40 and 41, respectively.

The hydraulic pressure supply device 30 includes the hydraulic pump 44 serving as a hydraulic-pressure generation unit which is a hydraulic-pressure source. The hydraulic pump 44 is rotationally driven by the electric motor 45. The electric motor 45 is driven by power fed from the second ECU 32. When the power feeding is stopped, the rotation of the electric motor 45 is stopped with the stop of the rotation of the hydraulic pump 44. A discharge side of the hydraulic pump 44 is connected through a check valve 46 to a portion of the brake pipeline 34, which is located on the downstream side of the supply control valve 37 (that is, at a position at which the first pipeline portion 35 and the second pipeline portion 36 branch). An intake side of the hydraulic pump 44 is connected to the reservoir 49 for hydraulic-pressure control through check valves 47 and 48.

The reservoir 45 for hydraulic-pressure control is provided to temporarily store an excessive brake fluid. The reservoir 49 for hydraulic-pressure control temporarily stores the excessive brake fluid flowing out from cylinder chambers of the disc brakes 5L and 54R not only at the time of ABS control for the brake system (hydraulic pressure supply device 30) but also at the time of other types of brake control. The intake side of the hydraulic pump 44 is connected to the cylinder-side hydraulic pipe 15A of the master cylinder 8 (that is, to a portion of the brake pipeline 34, which is located on the upstream side of the supply control valve 37) through the check valve 47 and a pressurization control valve 50 which is a normally-closed electromagnetic selector valve.

For each of the control valves 37, 37′, 38, 38′, 39, 39′, 42, 42′, 43, 43′, 50, and 50′ and the electric motor 45 for driving the hydraulic pumps 44 and 44′ that construct the hydraulic pressure supply device 30, operation control is performed in a predetermined procedure in accordance with a control signal output from the second ECU 32.

Specifically, the first hydraulic system 33 of the hydraulic pressure supply device 30 directly supplies the hydraulic pressure generated in the master cylinder 8 by the electric booster 16 to the disc brakes 5L and 54R through the brake pipeline 34, the first pipeline portion 35, and the second pipeline portion 36 at the time of a normal operation based on the braking operation (operation of the brake pedal 6) performed by the driver. For example, when antiskid control or the like is to be executed, the boost control valves 38 and 39 are closed to maintain the hydraulic pressure in the disc brakes 5L and 54R. When the hydraulic pressure in the disc brakes 5L and 54R is to be reduced, the pressure-reduction control valves 42 and 43 are opened so that the hydraulic pressure in the disc brakes 5L and 54R is exhausted to be released to the reservoir 49 for hydraulic-pressure control.

When the hydraulic pressure to be supplied to the disc brakes 5L and 54R is to be boosted for stabilization control (sideslip prevention control) or the like during running of the vehicle, the hydraulic pump 44 is actuated by the electric motor 45 under a state in which the supply control valve 37 is closed. In this manner, the brake fluid discharged from the hydraulic pump 44 is supplied to the disc brakes 5L and 54R through the first pipeline portion 35 and the second pipeline portion 36, respectively. At this time, the pressurization control valve 50 is opened. As a result, the brake fluid stored in the reservoir 14 is supplied from the master cylinder 8 side to the intake side of the hydraulic pump 44.

As described above, the second ECU 32 controls the actuation of the supply control valve 37, the boost control valves 38 and 39, the pressure-reduction control valves 42 and 43, the pressurization control valve 50, and the electric motor 45 (that is, the hydraulic pump 44) based on vehicle operation information and the like so as to appropriately maintain, reduce, or boost the hydraulic pressure to be supplied to the disc brakes 5L and 54R. As a result, the above-mentioned brake control such as the braking-force distribution control, the vehicle stabilization control, the brake assist control, the antiskid control, the traction control, and the hill start aid control is executed.

Meanwhile, in a normal braking mode which is performed under a state in which the electric motor 45 (that is, the hydraulic pump 44) is stopped, the supply control valve 37 and the boost control valves 38 and 39 are opened, whereas the pressure-reduction valves 42 and 43 and the pressurization control valve 50 are closed. In this state, when the first piston (that is, the booster piston 18 and the input rod 19) and the second piston 10 of the master cylinder 8 are displaced in the axial direction inside the cylinder main body 9 in accordance with the depressing operation of the brake pedal 6, the master pressure Pm generated in the first hydraulic chamber 11A is supplied from the cylinder-side hydraulic pipe 15A side through the first hydraulic system 33 and the brake-side pipe portions 31A and 31D of the hydraulic pressure supply device 30 to the disc brakes 5L and 54R. The master pressure Pm generated in the second hydraulic chamber 11B is supplied from the cylinder-side hydraulic pipe 15B side through the second hydraulic system 33′ and the brake-side pipe portions 31B and 31C to the disc brakes 5R and 54L.

Further, when the booster piston 18 cannot be actuated by the electric motor 21 due to a failure of the electric booster 16, the master pressure generated in the first hydraulic chamber 11A and the second hydraulic chamber 11B is detected by the hydraulic pressure sensor 29 connected to the second ECU 32 so as to perform assist control for boosting the pressure in each of the wheel cylinders so that the detection value becomes the wheel cylinder hydraulic pressure (wheel pressure Pw) in accordance with the detection value as the amount of operation of the brake pedal 6.

In the assist control, the pressurization control valve 50 and the boost control valves 38 and 39 are opened, while the supply control valve 37 and the pressure-reduction control valves 42 and 43 are appropriately opened and closed. In this state, the hydraulic pump 44 is actuated by the electric motor 45 so that the brake fluid discharged from the hydraulic pump 44 is supplied to the disc brakes 5L and 54R through the first pipeline portion 35 and the second pipeline portion 36, respectively. In this manner, the braking force by the disc brakes 5L and 54R can be generated by the brake fluid discharged from the hydraulic pump 44, based on the master pressure generated on the master cylinder 8 side.

A known hydraulic pump, such as a plunger pump, a trochoid pump, and a gear pump can be used as the hydraulic pump 44. In view of adaptability to vehicle installation, quietness, pump efficiency, and the like, the use of the gear pump is preferable. A known motor, such as a DC motor, a DC brushless motor, and an AC motor can be used as the electric motor 45. In this embodiment, the DC motor is used in view of adaptability to vehicle installation.

Characteristics of the control valves 37, 38, 39, 42, 43, and 50 of the hydraulic pressure supply device 30 can be appropriately set in accordance with a mode of use of each of the control valves. Among the above-mentioned control valves, the supply control valve 37 and the boost control valves 38 and 39 are configured as the normally-open valves, whereas the pressure-reduction control valves 42 and 43 and the pressurization control valve 50 are configured as the normally-closed valves. As a result, even when there is no control signal transmitted from the second ECU 32, the hydraulic pressure can be supplied from the master cylinder 8 to each of the disc brakes 5L, 5R, 54L, and 54R. Therefore, in view of fail safe and control efficiency of the brake system, the use of the above-mentioned configuration is preferable.

The G sensor 51 is configured to detect a deceleration of the vehicle, specifically, an acceleration acting in a forward direction and a rearward direction of the vehicle, and constructs the wheel cylinder hydraulic pressure detecting unit. When the brake operation is performed while the vehicle is running, the braking force is applied to each of the left and right front wheels 2 and the left and right rear wheels 3 of the vehicle by, for example, the disc brakes 5 and 54 to generate the deceleration. The G sensor 51 detects or calculates the deceleration generated at this time as an actual deceleration and outputs a detection signal thereof to the second ECU 32. The second ECU 32 outputs the deceleration to the first ECU 26. In this case, the first ECU 26 calculates the hydraulic pressure (wheel pressure Pw) of each of the wheel cylinders of the disc brakes 5 and the wheel cylinders 55A of the disc brakes 54.

The third ECU 52 is a regeneration controller configured to perform regenerative cooperation control for power charge. The third ECU 52 is connected to the first ECU 26, the second ECU 32, and the fourth ECU 61 via the vehicle data bus 28 mounted in the vehicle. The third ECU 52 controls the driving of a regeneration motor 53 by using an inertia force generated by rotation of the front wheels 2 and the rear wheels 3 when the vehicle is decelerated and when the vehicle is braked, thereby recovering a kinetic energy as electric power.

The disc brakes 54 (L, R) are provided to the left and right rear wheels 3 (RL, RR), respectively. The disc brakes 54 are constructed as hydraulic disc brakes having the electric parking brake function. Each of the disc brakes 54 includes a caliper 55 and a wheel piston 56. The wheel piston 56 constructs a pressing member configured to press brake pads 57 against the disc rotor 4, and is provided so as to be slidable on an inner periphery of the wheel cylinder 55A of the caliper 55.

The caliper 55 moves the wheel piston 56 forward by the hydraulic pressure generated based on the operation of the brake pedal 6 to press (thrust) the brake pads 57 serving as friction members against the disc rotor 4. In this manner, the disc brakes 54 apply the braking forces to the left and right rear wheels 3, respectively. The caliper 55 (wheel cylinder 55A) and the wheel piston 56 of each of the disk brakes 54 have configurations generally similar to those of the caliper and the wheel piston of each of the disc brakes 5 provided to the left and right front wheels 2.

Further, the disc brake 54 is constructed together with the fourth ECU 61 described later as another braking unit according to the embodiment of the present invention. Specifically, each of the disc brakes 54 includes the electric actuator 53 configured to electrically move the wheel piston 56 forward independently of a case where the wheel piston 56 is moved forward by the hydraulic pressure of the brake fluid. The electric actuator 58 is constructed of a linear motion mechanism 59 and an electric motor 60. The linear motion mechanism 59 converts rotation of the electric motor 60 into advancing and retreating movement (axial movement) to press the wheel piston 56. Therefore, the wheel piston 56 performs the advancing and retreating movement by the hydraulic pressure (wheel pressure Pw) of the brake fluid in some cases, and performs the advancing and retreating movement by rotational driving of the electric motor 60 in other cases.

When a parking brake switch 62 is operated for brake ON, specifically, when the parking brake is applied, a rotational motion of the electric motor 60 is converted into a translational motion by the linear motion mechanism 59 to push the wheel piston 56 in a forward movement direction, thereby pressing the pair of brake pads 57 against the disc rotor 4. In this manner, each of the disc brakes 54 moves the wheel piston 56 by the electric motor 60 to maintain the wheel piston 56 in a braking state.

Meanwhile, when the parking brake switch 62 is operated for brake OFF, specifically, when the parking brake is released, the rotational motion of the electric motor 60 is converted into the translational motion by the linear motion mechanism 59 to release a pressing force generated by the wheel piston 56. Further, the electric actuator 58 is also actuated based on a signal from the first ECU 26.

The fourth ECU 61 is configured to control the disc brakes 54 (L, R), and constructs another braking unit of the embodiment of the present invention. An input side of the fourth ECU 61 is connected to the parking brake switch 62, the vehicle data bus 26, and the like. Meanwhile, an output side of the fourth ECU 61 is connected to each of the electric motors 60 of the disc brakes 54, the vehicle data bus 28, and the like. The fourth ECU 61 outputs a signal from the parking brake switch 62 to the vehicle data bus 28 and drives the electric motor 60 in accordance with the signal from the parking brake switch 62 to switch each of the disc brakes 54 into a braking state or a braking release state. Further, the fourth ECU 61 drives the electric motor 60 based on the signal output from the first ECU 26 to switch each of the disc brakes 54 into the braking state or the braking release state.

The brake control device according to this embodiment has the configuration described above. The actuation of the brake control device is now described.

First, when the driver of the vehicle performs the depressing operation of the brake pedal 6, the input rod 19 is pressed in the direction indicated by the arrow A. At the same time, the actuation of the electric actuator 20 for the electric booster 16 is controlled by the first ECU 26. Specifically, the first ECU 26 outputs a start command to the electric motor 21 in response to the detection signal output from the stroke sensor 7 to rotationally drive the electric motor 21. The rotation of the electric motor 21 is transmitted to the cylindrical rotary body 22 via the speed-reducer mechanism 23. Then, the rotation of the cylindrical rotary body 22 is converted into the axial displacement of the booster piston 18 by the linear-motion mechanism 24.

As a result, the booster piston 18 for the electric booster 16 moves forward generally integrally with the input rod 19 toward the cylinder main body 9 of the master cylinder 8. The master pressure in accordance with the depressing force (thrust force) applied from the brake pedal 6 to the input rod 19 and the booster thrust force applied from the electric actuator 20 to the booster piston 18 are generated in the first hydraulic chamber 11A and the second hydraulic chamber 11B of the master cylinder 8.

The first ECU 26 receives the detection signal detected by the hydraulic-pressure sensor 29 from the signal line 27 via the second ECU 32 to monitor the hydraulic pressure generated in the master cylinder 8. In this manner, the first ECU 25 performs feedback control on the electric actuator 20 of the electric booster 16 (rotation of the electric motor 21). In this manner, the first ECU 26 can variably control the master pressure Pm generated in the first hydraulic chamber 11A and the second hydraulic chamber 11B of the master cylinder 8 in accordance with the amount of the depressing operation of the brake pedal 6. The first ECU 26 can determine whether or not the electric booster 16 is operating normally in accordance with the detection value of the stroke sensor 7 and the detection value of the hydraulic-pressure sensor 23.

Meanwhile, the input red 19, which is coupled to the brake pedal 6, is subjected to the pressure generated in the first hydraulic chamber 11A and transmits the pressure as the brake reaction force to the brake pedal 6. As a result, a firm pedal feeling can be provided to the driver of the vehicle through the input rod 19. As a result, the operation feel of the brake pedal 6 can be improved to keep a good pedal feeling.

At this time, the hydraulic pressure supply device 30 distributes and supplies the master pressure Pm generated by the electric booster 16 in the master cylinder 8 (first hydraulic chamber 11A and second hydraulic chamber 11B) from the cylinder-side hydraulic pipes 15A and 15B through the first hydraulic system 33 and the second hydraulic system 33′and the brake-side pipe portions 31A, 31B, 31C, and 31D included in the hydraulic pressure supply device 30 to the disc brakes 5 (L, R) and 54 (L, R) as the wheel-cylinder pressures Pw for the front wheels 2 and rear wheels 3 while variably controlling the master pressure Pm. As a result, an appropriate braking force is applied to each of the front wheels 2 (FL, FR) and rear wheels 3 (RL, RR) of the vehicle through each of the disc brakes 5 (L, R) and 54 (L, R).

Incidentally, the brake fluid has a property of increasing a kinetic viscosity at a low temperature. At an ultralow temperature, in particular, the kinetic viscosity of the brake fluid increases exponentially. Therefore, a flow resistance of the brake fluid increases. As a result, there is a problem in that the hydraulic pressure of the wheel cylinder is not increased in association with the amount of operation of the brake pedal operation to lower the responsiveness of the vehicle braking.

Therefore, in a related-art brake control device, an opening degree of an orifice provided to a hydraulic pipeline is adjusted in accordance with the temperature of the brake fluid. Specifically, by increasing the opening degree of the orifice at the low temperature, the hydraulic pressure is applied from the master cylinder to the wheel cylinder after the flow resistance of the brake fluid is reduced. However, the orifice itself is present in the brake control device described above. Therefore, at the ultralow temperature, there is a fear in that the brake hydraulic pressure of the wheel cylinder cannot be increased sufficiently due to the flow resistance of the brake fluid, resulting in lowered responsiveness of the vehicle braking to the brake pedal operation.

Therefore, in this embodiment, the first ECU 26 compares the hydraulic pressure (master pressure Pm) of the master cylinder 8 and the hydraulic pressure (wheel pressure Pw) of the wheel cylinder (disc brakes 5 and 54). The first ECU 26 is configured to output the braking instruction signal to the fourth ECU 61 to actuate the electric actuator 58 for the disc brake 54 when a deviation between the master pressure Pm and the wheel pressure Pw is large.

In this manner, the responsiveness of the brake control can be improved at the low temperature. Further, the low temperature of the brake fluid is detected indirectly by comparing the master cylinder hydraulic pressure Pm and the wheel cylinder hydraulic pressure Pw without proving a temperature sensor configured to detect the fluid temperature of the brake fluid. Thus, cost can be reduced.

Next, brake control processing performed by the first ECU 26 is described with reference to FIG. 4. The processing illustrated in FIG. 4 is repeatedly executed at predetermined time intervals (at predetermined control intervals) while the first ECU 26 is energized. Further, for each step of a flowchart of FIG. 4, a notation “S” is used. For example, Step 1 is denoted as “S1”.

After a processing operation illustrated in FIG. 4 is started, whether or not the brake pedal 6 is currently being operated (the depressing operation is currently being performed) is determined in S1. The determination is detected by the stroke sensor 7. Instead, the determination may be determination of, for example, whether or not the first ECU 26 is automatically performing the brake control instead of determining the operation of the brake pedal 6. When it is determined “YES” in S1, specifically, the driver is performing the depressing operation on the brake pedal 6, the processing proceeds to S2. Meanwhile, when it is determined “NO” in S1, specifically, the driver is not operating the brake pedal 6, the processing returns.

In S2, the master cylinder hydraulic pressure (master pressure) Pm is detected. Specifically, the master cylinder hydraulic pressure detecting unit of the first ECU 26 acquires the master cylinder hydraulic pressure Pm detected by the hydraulic pressure sensor 29 via the second ECU 32. The detection of the master pressure Pm is repeatedly executed at predetermined time periods (at predetermined control periods) while the brake pedal 6 is being operated. A detected value is stored (updated) in the memory 26A continually.

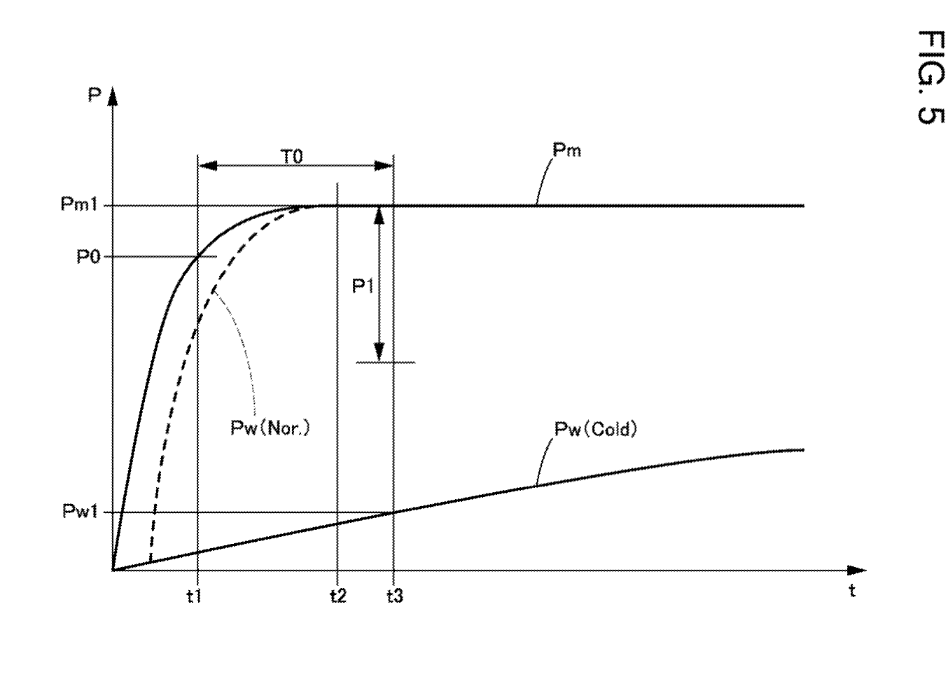

In subsequent S3, whether or not the master pressure Pm continues to be high is determined by determining whether or not the master pressure Pm is equal to or larger than a threshold value P0 (Pm≧P0) in a continuous manner for T0 second or longer. Specifically, the timer unit of the first ECU 26 measures duration time from a time at which the master pressure Pm detected by the hydraulic pressure sensor 29 reaches P0. In this case, a value of the threshold value P0 is a hydraulic pressure corresponding to an emergency brake, specifically, braking performed when the brake pedal 6 is stepped on strongly, and is set, for example, as a hydraulic pressure at which each of the disc brakes 5 and 54 is locked. Further, a value of the duration time T0 second is set larger than a follow delay time (see the dotted line in FIG. 5) of the wheel pressure Pw with respect to the master pressure Pm when the temperature is not low (at a normal temperature) and is set to, for example, 0.3 second.

When it is determined “YES” in S3, specifically, the master pressure Pm is equal to or larger than the threshold value P0 in a continuous manner for T0 second or longer, it is determined that the master pressure Pm continues to be high and there is a possibility of a high viscosity of the brake fluid. Thus, the processing proceeds to S4. Meanwhile, when it is determined “NO” in S3, specifically, the master pressure Pm is not equal to or larger than the threshold value P0 in a continuous manner for T0 second or longer, the processing returns to S1.

In S4, a wheel cylinder hydraulic pressure (wheel pressure) Pw1 is calculated from the deceleration. Specifically, when the master pressure Pm is equal to or larger than the threshold value P0 in a continuous manner for T0 second, the wheel cylinder hydraulic pressure detecting unit of the first ECU 26 calculates the wheel pressure Pw1 in a case where the master pressure Pm is equal to or larger than the threshold value P0 in a continuous manner for T0 second. More specifically, the wheel cylinder hydraulic pressure detecting unit of the first ECU 26 acquires the deceleration detected by the G sensor 51 via the second ECU 32 to calculate the wheel pressure Pw1 from the deceleration.

In this case, a correspondence relationship between the deceleration and the wheel pressure is stored in the form of map in the memory 26A so that the wheel pressure Pw1 can be calculated from the map. Further, a computational expression which allows the wheel pressure to be calculated from the deceleration may be stored in the memory 26A so that the wheel pressure Pw1 is calculated by the computational expression. The calculated wheel pressure Pw1 is stored in the memory 26A.

In subsequent S5, whether or not the wheel pressure Pw has a follow delay with respect to the master pressure Pm is determined based on whether or not a difference between a master pressure Pm1 and the wheel pressure Pw1 in the case where the master pressure Pm is equal to or larger than the threshold value P0 in a continuous manner for T0 second is equal to or larger than a threshold value P1 (Pm1−Pw1≧P1). In other words, it is determined whether or not a degree of increase (a rate of increase or a change rate of increase) in physical quantity of the wheel pressure Pw is small with respect to a temporal change in physical quantity of the master pressure Pm. In this case, the threshold value P1 is set to a value which is smaller than the threshold value P0 used in S3 and is sufficiently larger than an error considered to be generated when the wheel pressure Pw1 is calculated in S4. For example, the threshold value P1 is set to half of P0 (P1=P0/2).

Then, when it is determined “YES” in S5, specifically, the difference between the master pressure Pm1 and the wheel pressure Pw1 in the case where the master pressure Pm is equal to or larger than the threshold value P0 in a continuous manner for 70 second is equal to or larger than the threshold value P1, the processing proceeds to S6. Meanwhile, when it is determined that the difference between the master pressure Pm1 and the wheel pressure Pw1 in the case where the master pressure Pm is equal to or larger than the threshold value P1 for T0 second is smaller than the threshold value P1, the processing returns to S1.

In S6, the brake fluid temperature detecting unit of the first ECU 25 detects that the temperature of the brake fluid is low. Specifically, the brake fluid has the property of increasing the kinetic viscosity at a low temperature. Therefore, based on the difference between the master pressure Pm and the wheel pressure Pw being equal to or larger than the threshold value P1, specifically, the wheel pressure Pw failing to follow the master pressure Pm, the brake fluid temperature detecting unit of the first ECU 26 detects that the kinetic viscosity of the brake fluid is high and therefore the brake fluid is in a low temperature state. Then, the processing proceeds to subsequent S7.

In subsequent S7, a braking actuation command to the other braking mechanism, which is the electric parking brake (disc brake 54) in this embodiment, is issued. Specifically, when it is determined “YES” in S5, the brake fluid has a high viscosity, and therefore the follow delay of the wheel pressure Pw with respect to the master pressure Pm has occurred. Thus, the responsiveness of the brake control is lowered as compared to that at the normal temperature.

Therefore, the output unit of the first ECU 26 outputs the braking instruction signal (actuation command) to the fourth ECU 61. Then, the fourth ECU 61 actuates the electric actuator 58 (electric motor 60) for each of the disc brakes 54 based on the braking instruction signal. Specifically, each of the disc brakes 54 starts application. As a result, the linear motion mechanism 59 for each of the disc brakes 54 presses the wheel piston 56. Hence, the braking force of each of the disc brakes 54 can be increased. Therefore, even when the follow delay of the wheel pressure Pw has occurred with respect to the master pressure Pm at the low temperature, the responsiveness of the brake control can be improved by actuating the electric actuator 58 for each of the disc brakes 54.

In subsequent S8, whether or not the ABS is currently being actuated is determined. Specifically, after elapse of a sufficient period of time from the start of the operation of the brake pedal 6 performed by the driver, the wheel pressure Pw is increased (follows the master pressure Pm) to reach a lock hydraulic pressure (P0). Then, the disc brakes 5 and 54 lock the front wheels 2 and the rear wheels 3, respectively.

When detecting that the front wheels 2 and the rear wheels 3 are locked, the second ECU 32 controls the actuation of the hydraulic pressure supply device 30 so as to perform anti-lock brake control which is so-called “ABS control” for automatically adjusting the braking forces to the front wheels 2 and the rear wheels 3 and preventing the front wheels 2 and the rear wheels 3 from being locked. In this case, the second ECU 32 outputs an actuated ABS indication signal to the first ECU 26. Then, when it is determined “YES” in S3, specifically, the first ECU 25 determines that the ABS is currently being actuated based on acquisition (reception) of the actuated ABS indication signal from the second ECU 32, the processing proceeds to S9. Meanwhile, when it is determined “NO” in S8, specifically, the ABS is not currently being actuated, monitoring of whether or not the ABS is currently being actuated is continued.

In S9, a braking release command to the other braking mechanism, which is the electric parking brake (disc brake 54) in this embodiment, is issued. Specifically, after the first ECU 25 outputs a release signal (release command) for the braking instruction signal to the fourth ECU 61, the processing returns. In this case, the fourth ECU 61 actuates the electric actuator 58 (electric motor 60) for each of the disc brakes 54 based on the release signal. Specifically, the disc brake 54 releases braking. In this manner, the linear motion mechanism 59 for each of the disc brakes 54 releases the pressing force applied by the wheel piston 56. Therefore, the second ECU 32 controls the actuation of the hydraulic pressure supply device 30 to perform appropriate ABS control.

Next, a temporal change in the master pressure Pm and a temporal change in the wheel pressure Pw when the driver performs the depressing operation on the brake pedal 6 are described with reference to a characteristic line graph of FIG. 5.

When the driver performs the depressing operation on the brake pedal 6, the input rod 19 is pushed in the direction indicated by the arrow A. The first ECU 26 drives the electric motor 21 based on the amount of operation of the brake pedal 6, which is detected by the stroke sensor 7. As a result, the booster piston 18 for the electric booster 16 is moved forward generally integrally with the input rod 19 into the cylinder main body 9 of the master cylinder 8 to generate the master pressure Pm in the first hydraulic chamber 11A and the second hydraulic chamber 11B of the master cylinder 8 in accordance with the depressing force (thrust force) applied from the brake pedal 6 to the input rod 19 and the booster thrust force applied from the electric actuator 20 to the booster piston 18.

When the amount of depressing operation on the brake pedal 6 increases, the master pressure Pm also increases along therewith. Then, when the master pressure Pm becomes equal to or larger than P0 at a time t1, the timer unit of the first ECU 26 starts measuring duration time of a state in which the master pressure Pm is equal to or larger than P0.

After elapse of T0 from the time t1, which is measured by the timer unit, specifically, at a tine t3 at which the duration time of the state in which the master pressure Pm is equal to or larger than P0 reaches T0, the first ECU 26 determines whether or not the difference between the master pressure Pm1 at this time and the wheel pressure Pw1 calculated based on the deceleration detected by the G sensor 51 is equal to or larger than the threshold value P1 (Pm1−Pw1≧P0) (S5 of FIG. 4). Specifically, the first ECU 26 determines whether or not the wheel pressure Pw follows the master pressure Pm.

In this case, as indicated by the dotted line of FIG. 5, the wheel pressure Pw at the normal temperature (at a normal temperature of the brake fluid) follows the master pressure Pm. Specifically, at a time t2 before elapse of the duration time T0 from the start of the measurement of time by the timer unit of the first ECU 26, the wheel pressure Pw has approximately the same value as the master pressure Pm1. Therefore, at the time t3, the difference between the master pressure Pm1 and the wheel pressure Pw becomes smaller than the threshold value P1. In other words, a temporal change in the physical quantity of the master pressure Pm and a temporal change in the physical quantity of the wheel pressure Pw become approximately the same. In this manner, the first ECU 26 determines that the brake hydraulic pressure obtained based on the amount of operation of the brake pedal 6 is applied to each of the disc brakes 5 and 54.

Meanwhile, at the low temperature (at the low temperature of the brake fluid), the kinetic viscosity of the brake fluid becomes high. Therefore, the flow resistance of the brake fluid is increased to increase (delay) follow time of the wheel pressure Pw with respect to the master pressure Pm. The degree of increase (the rate of increase or the change rate of increase) in the physical quantity of the wheel pressure Pw becomes small with respect to the temporal change in the physical quantity of the master pressure Pm. Therefore at the time t3, the difference between the master pressure Pm1 and the wheel pressure Pw becomes equal to or larger than the threshold value P1. In this manner, the first ECU 26 determines that the brake hydraulic pressure obtained based on the amount of operation of the brake pedal 6 is not applied to each of the disc brakes 5 and 54.

Therefore, the first ECU 26 outputs the braking instruction signal (actuation command) to the fourth ECU 61 at the time t3. The fourth ECU 61 actuates the electric actuator 58 (electric motor 60) for the disc brake 54 based on the braking instruction signal. Specifically, the disc brake 54 starts the application. In this manner, the linear motion mechanism 59 for the disc brake 54 presses the wheel piston 56 and hence the braking force of the disc brake 54 can be increased. Therefore, the follow delay of the wheel pressure Pw with respect to the master pressure Pm at the low temperature is compensated for by the electric actuator 58 for the disc brake 54. In this manner, the responsiveness of the brake control can be improved.

After the time t3, when the value of the wheel pressure Pw reaches the lock hydraulic pressure (P0), the disc brakes 5 and 54 lock the front wheels 2 and the rear wheels 3, respectively. In this case, the second ECU 32 controls the actuation of the hydraulic pressure supply device 30, thereby performing the anti-lock brake control (so-called “ABS control”). At this time, when the fourth ECU 61 drives the electric motor 60 for the disc brake 54 based on the braking instruction signal from the first ECU 26 so that the braking force continues to be applied to the disc rotor 4, normal ABS control cannot be performed.

Therefore, the second ECU 32 controls the actuation of the hydraulic pressure supply device 30 so that the actuated ABS indication signal is output to the first ECU 26 when the ABS control is performed. When acquiring (receiving) the actuated ABS indication signal, the first ECU 26 outputs the release signal (release command) for the braking instruction signal to the fourth ECU 61. Then, when acquiring the release signal for the braking instruction signal, the fourth ECU 61 actuates the electric actuator 58 (electric motor 60) for the disc brake 54 in a releasing direction. In this manner, the braking state of the disc brake 54 achieved by the electric actuator 58 is released. Therefore, the second ECU 32 can perform the normal ABS control.

As described above, according to this embodiment, when the value of the master pressure Pm is equal to or larger than P0 in a continuous manner for T0 second, the first ECU 26 calculates the difference between the value of the master pressure Pm and the value of the wheel pressure Pw, and detects the low-temperature state when the value of the difference is equal to or larger than the threshold value P1. At this time, the first ECU 26 outputs the braking instruction signal to the fourth ECU 61 so as to actuate the electric actuator 58 for the disc brake 54.

In this manner, the fourth ECU 61 actuates the electric motor 60 for the disc brake 54 to perform the application, and hence the responsiveness of the brake control can be improved. Further, the first ECU 26 indirectly detects that the liquid temperature of the brake fluid is in the low temperature state without providing a temperature sensor configured to detect a liquid temperature of the brake fluid. Thus, the cost can be reduced.

Further, the brake control device according to one embodiment of the present invention is the brake control device configured to brake the vehicle by the hydraulic pressure control mechanism configured to apply the brake hydraulic pressure from the master cylinder to the wheel cylinder, and includes the brake fluid temperature detecting unit configured to detect the liquid temperature of the brake hydraulic pressure and the braking instruction signal output unit configured to output the braking instruction signal to the other braking unit in the vehicle when the brake fluid temperature detecting unit detects that the liquid temperature of the brake fluid is low. With this configuration, even when the kinetic viscosity of the brake fluid becomes high at the low temperature, the vehicle can be braked by the other braking unit. Thus, the responsiveness of the brake control can be improved.

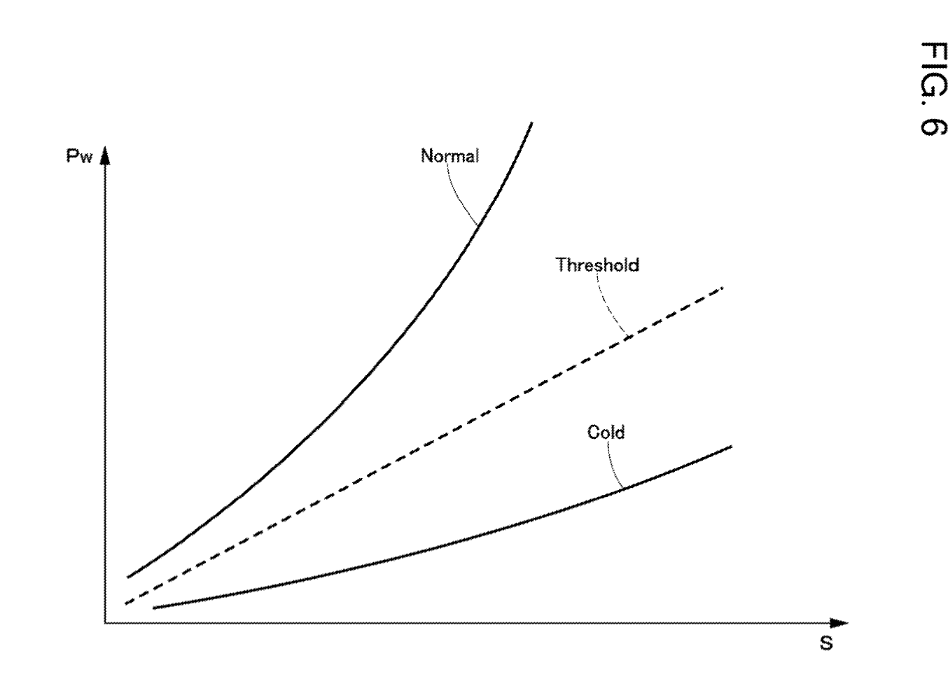

Further, in the embodiment, there has been described, as an example, the case where the braking instruction signal is output under a condition in which the difference between the master pressure Pm and the wheel pressure Pw becomes larger than the threshold value P1 for the determination of whether or not the wheel pressure Pw has the follow delay with respect to the master pressure Pm in S5 illustrated in FIG. 4. However, the embodiment of the present invention is not limited thereto. For example, as in a modification example shown in FIG. 6, the first ECU 26 may be configured to output the braking instruction signal when a movement amount S of the first piston and the second piston 10 of the master cylinder 8 with respect to the wheel pressure Pw is equal to or larger than a predetermined value. Specifically, the first ECU 26 may be configured to determine that the difference between the master pressure Pm and the wheel pressure Pw is larger than the threshold value P1 and to output the braking instruction signal to the fourth ECU 61 when the wheel hydraulic pressure Pw is small with respect to the movement amount S of the pistons of the master cylinder 8. Further, the condition in which the difference between the master pressure Pm and the wheel pressure w becomes larger than the threshold value P1 is supposed to correspond not only to a state in which the brake fluid has the high viscosity at the low temperature but also to a state in which the vehicle deceleration does not become large due to brake fade although the master pressure Pm is large. For distinction from the brake fade described above, in addition to the above-mentioned condition, a condition of whether or not the movement amount S of the first piston and the second piston 10 of the master cylinder 8 with respect to the master pressure Pm becomes equal to or smaller than a predetermined value may be added as the condition for determination of whether or not the wheel pressure Pw has the follow delay with respect to the master pressure Pm in S5. Specifically, when the brake fluid has the high viscosity at the low temperature, the master pressure Pm tends to become large even under a state in which the movement amount S of the first piston and the second piston 10 of the master cylinder 8 is small. Meanwhile, under a brake fade state, even when the brake pedal is stepped on to increase the master pressure Pm, the vehicle deceleration does not become large, and therefore the brake pedal is further stepped on. Thus, the movement amount of the first piston and the second piston 10 of the master cylinder 8 tends to become large. Therefore, based on the condition of whether or not the movement amount S of the first piston and the second piston 10 of the master cylinder 8 with respect to the master pressure Pm is equal to smaller than the predetermined value, the state in which the brake fluid has the high viscosity at the low temperature and the brake fade state can be distinguished from each other. Thus, accuracy for improving the responsiveness of the brake control can be further improved.

Further, in the embodiment, the disc brake 54 serving as the electric parking brake mechanism has been described as an example of the other braking unit for applying the braking force to the vehicle. However, the embodiment of the present invention is not limited thereto. For example, the first ECU 26 may drive the regeneration motor 53 to apply the braking force to the vehicle by outputting the braking instruction signal to the third ECU 52. Further, the first ECU 26 may apply the braking force to the vehicle by controlling a transmission (not shown) to downshift a gear, for example, from a fourth gear to a third gear, from the third gear to a second gear or a first gear, or the like. The braking instruction signal may be output to the other braking unit for a combination of the above-mentioned two items or all the items.

Further, in the embodiment, there has been described, as an example, the case where the master pressure Pm is generated in the master cylinder 8 via the electric booster 16. However, the embodiment of the present invention is not limited thereto. For example, a pneumatic booster used as a negative pressure booster may be used in place of the electric booster 16.

Further, in the embodiment, there has been described, as an example, the case where the master pressure Pm is generated by the electric booster 16. However, the embodiment of the present invention is not limited thereto. For example, the hydraulic pressure may be increased by the hydraulic pump 44 of the hydraulic pressure supply device 30 without using the electric booster 16. In this case, a hydraulic sensor may be provided to the hydraulic pressure supply device 30 so that a hydraulic pressure detected by the hydraulic sensor is regarded as the master pressure Pm.

Further, in the embodiment, there has been described, as an example, the case where whether or not the brake pedal 6 is operated is determined based on the detection of the stroke sensor 7 in S1. However, the embodiment of the present invention is not limited thereto. For example, it may be determined that the brake pedal 6 is operated based on the detection of the master pressure by the hydraulic pressure sensor 25 in S1.

Further, in the embodiment, there has been described, as an example, the case where the wheel cylinder hydraulic pressure Pw is calculated based on the acceleration (deceleration) detected by the G sensor 51. However, the embodiment of the present invention is not limited thereto. For example, the wheel cylinder hydraulic pressure Pw may be detected with hydraulic pressure sensors provided to the disc brakes 4 and 54.

Further, in the embodiment, there has been described, as an example, the case where the first ECU 26 includes the master cylinder hydraulic pressure detecting unit, the timer unit, the wheel cylinder hydraulic pressure detecting unit, and the braking instruction signal output unit. However, the embodiment of the present invention is not limited thereto. For example, the second ECU 32, the third ECU 52, and the fourth ECU 61 or a different ECU may include the master cylinder hydraulic pressure detecting unit, the timer unit, the wheel cylinder hydraulic pressure detecting unit, and the braking instruction signal output unit.

Further, in the embodiment, there has been described, as an example, the case where the hydraulic disc brakes 5 and 54 configured to press the brake pads against the disc rotors 4 rotating together with the wheels 2 and 3 to generate the braking forces are used. However, the embodiment of the present invention is not limited thereto. For example, other hydraulic brakes, such as a drum brake, may be used.

Still further, as the brake control device according to the embodiment, for example, the following aspects are conceivable.

According to a first aspect, there is provided a brake control device configured to brake a vehicle by a hydraulic pressure control mechanism configured to apply a hydraulic pressure from a master cylinder to a wheel cylinder. The brake control device includes: a master cylinder hydraulic pressure detecting unit configured to detect or calculate a physical quantity relating to a hydraulic pressure generated in the master cylinder; a wheel cylinder hydraulic pressure detecting unit configured to detect or calculate a physical quantity relating to a hydraulic pressure of the wheel cylinder; and control unit configured to control whether or not to output a braking instruction signal to another braking unit provided in the vehicle in accordance with a difference between the physical quantity of the hydraulic pressure of the master cylinder, which is detected or calculated by the master cylinder hydraulic pressure detecting unit, and the physical quantity of the hydraulic pressure of the wheel cylinder, which is detected or calculated by the wheel cylinder hydraulic pressure detecting unit.

According to a second aspect, in the first aspect, the wheel cylinder hydraulic pressure detecting unit is configured to calculate the hydraulic pressure of the wheel cylinder based on an acceleration of the vehicle.

According to a third aspect, in the first or second aspect, the control unit is configured to output the braking instruction signal when the difference between the hydraulic pressure of the master cylinder and the hydraulic pressure of the wheel cylinder becomes larger than a predetermined value or when a degree of increase in the physical quantity of the hydraulic pressure of the wheel cylinder is small with respect to a temporal change in the physical quantity of the hydraulic pressure of the master cylinder.

According to a fourth aspect, in any one of the first to third aspects, the other braking unit includes at least one of an electric parking brake mechanism configured to move a piston of the wheel cylinder by an electric motor, a regeneration mechanism configured to convert a kinetic energy of the vehicle into an electric energy to perform braking, or downshifting achieved by a transmission.

According to a fifth aspect, in any one of the first to fourth aspects, the control unit is configured to output the braking instruction signal when a movement amount of a piston of the master cylinder with respect to the hydraulic pressure of the master cylinder is equal to or smaller than a predetermined value.

According to a sixth aspect, there is provided a brake control method for braking a vehicle by a hydraulic pressure control mechanism configured to apply a hydraulic pressure from a master cylinder to a wheel cylinder. The brake control method includes: detecting or calculating a physical quantity relating to a hydraulic pressure generated in the master cylinder; detecting or calculating a physical quantity relating to a hydraulic pressure of the wheel cylinder; and determining need to brake the vehicle by a method other than application of the hydraulic pressure to the wheel cylinder, in accordance with a difference between the detected or calculated physical quantity of the hydraulic pressure of the master cylinder and the detected or calculated physical quantity of the hydraulic pressure of the wheel cylinder.

According to a seventh aspect, there is provided a brake control device configured to brake a vehicle by a hydraulic pressure control mechanism configured to apply a hydraulic pressure from a master cylinder to a wheel cylinder. The brake control device includes: a master cylinder hydraulic pressure detecting unit configured to detect or calculate a physical quantity relating to a hydraulic pressure generated in the master cylinder; a wheel cylinder hydraulic pressure detecting unit configured to detect or calculate a physical quantity relating to a hydraulic pressure of the wheel cylinder; another braking unit provided in the vehicle; and control unit configured to control whether or not to output a braking instruction signal to the other braking unit provided in the vehicle in accordance with a difference between the physical quantity of the hydraulic pressure of the master cylinder, which is detected or calculated by the master cylinder hydraulic pressure detecting unit, and the physical quantity of the hydraulic pressure of the wheel cylinder, which is detected or calculated by the wheel cylinder hydraulic pressure detecting unit.

The embodiments of the present invention have been described above. The embodiments of the present, invention described above are intended for easy understanding of the present invention, and do not limit the present invention. It is to be understood that the present invention can be changed and modified without departing from the spirit thereof and encompasses equivalents thereof. Further, within a range in which the above-mentioned problem can be at least partially solved or within a range in which the above-mentioned effects are at least partially obtained, a suitable combination or omission of the components recited in the claims and described in the specification is possible.

The present application claims priority to the Japanese Patent Application No. 2015-074003 filed on Mar. 31, 2015. The entire disclosure including the specification, the claims, the drawings, and the abstract of Japanese Patent Application No. 2015-074003 filed on Mar. 31, 2015 is incorporated herein in its entirety by reference.

### REFERENCE SIGNS LIST

5 disc brake, 8 master cylinder, 26 first ECU, 29 hydraulic pressure sensor (master cylinder hydraulic pressure detecting unit), 30 hydraulic pressure supply device (ESC), 32 second ECU, 51 G sensor (wheel cylinder hydraulic pressure detecting unit), 52 third ECU, 53 regeneration motor, 54 disc brake, 55 caliper, 55A wheel cylinder, 58 electric actuator, 60 electric motor, 61 fourth ECU

1. A brake control device configured to brake a vehicle by a hydraulic pressure control mechanism configured to apply a hydraulic pressure from a master cylinder to a wheel cylinder, the brake control device comprising:
a master cylinder hydraulic pressure detecting unit configured to detect or calculate a physical quantity relating to a hydraulic pressure generated in the master cylinder;
a wheel cylinder hydraulic pressure detecting unit configured to detect or calculate a physical quantity relating to a hydraulic pressure of the wheel cylinder; and
a control unit configured to control whether or not to output a braking instruction signal to another braking unit provided in the vehicle in accordance with a difference between the physical quantity of the hydraulic pressure of the master cylinder, which is detected or calculated by the master cylinder hydraulic pressure detecting unit, and the physical quantity of the hydraulic pressure of the wheel cylinder, which is detected or calculated by the wheel cylinder hydraulic pressure detecting unit.

2. A brake control device according to claim 1, wherein the wheel cylinder hydraulic pressure detecting unit is configured to calculate the hydraulic pressure of the wheel cylinder based on an acceleration of the vehicle.

3. A brake control device according to claim 1, wherein the control unit is configured to output the braking instruction signal when the difference between the hydraulic pressure of the master cylinder and the hydraulic pressure of the wheel cylinder becomes larger than a predetermined value or w hen a degree of increase in the physical quantity of the hydraulic pressure of the w heel cylinder is small with respect to a temporal change in the physical quantity of the hydraulic pressure of the master cylinder.

4. A brake control device according to claim 1, wherein the other braking unit comprises at least one of an electric parking brake mechanism configured to move a piston of the wheel cylinder by an electric motor, a regeneration mechanism configured to convert a kinetic energy of the vehicle into an electric energy to perform braking, or downshifting achieved by a transmission.

5. A brake control device according to claim 1, wherein the control unit is configured to output the braking instruction signal when a movement amount of a piston of the master cylinder with respect to the hydraulic pressure of the master cylinder is equal to or smaller than a predetermined value.

6. A brake control method for braking a vehicle by a hydraulic pressure control mechanism configured to apply a hydraulic pressure from a master cylinder to a wheel cylinder, the brake control method comprising:
detecting or calculating a physical quantity relating to a hydraulic pressure generated in the master cylinder;
detecting or calculating a physical quantity relating to a hydraulic pressure of the wheel cylinder, and
determining need to brake the vehicle by a method other than application of the hydraulic pressure to the wheel cylinder, in accordance with a difference between the detected or calculated physical quantity of the hydraulic pressure of the master cylinder and the detected or calculated physical quantity of the hydraulic pressure of the wheel cylinder.

7. A brake control device configured to brake a vehicle by a hydraulic pressure control mechanism configured to apply a hydraulic pressure from a master cylinder to a wheel cylinder, the brake control device comprising:
a master cylinder hydraulic pressure detecting unit configured to detect or calculate a physical quantity relating to a hydraulic pressure generated in the master cylinder;
a wheel cylinder hydraulic pressure detecting unit configured to detect or calculate a physical quantity relating to a hydraulic pressure of the wheel cylinder,
another braking unit provided in the vehicle; and
a control unit configured to control whether or not to output a braking instruction signal to the other braking unit provided in the vehicle in accordance with a difference between the physical quantity of the hydraulic pressure of the master cylinder, which is detected or calculated by the master cylinder hydraulic pressure detecting unit, and the physical quantity of the hydraulic pressure of the wheel cylinder, which is detected or calculated by the wheel cylinder hydraulic pressure detecting unit.
